(19) United States
(12) Patent Application Publication
(10) Pub. No.: US 2012/0024567 A1
(43) Pub. Date: Feb. 2, 2012

(54) Cross-linkable polymer mixture for casings of cables and lines

(76) Inventors: Christian Cornelissen, Monchengladbach (DE); Peter Ulfig, Mehren (DE)

(21) Appl. No.: 13/152,578

(22) Filed: Jun. 3, 2011

(30) Foreign Application Priority Data
Jul. 30, 2010 (EP) 10 305 845.9

(51) Int. Cl. H01B 3/30; C08J 3/24; C08L 31/04; C08L 51/06; C08K 3/34; C08J 3/28

(52) U.S. Cl. 174/110 SR; 524/447; 522/83

(57) ABSTRACT

The invention provides a polymer mixture which is cross-linkable and halogen-free. The polymer mixture is particularly suitable as casing for cables or lines and is distinguished by a high cold strength and resistance to oils.

### RELATED APPLICATION

This application claims the benefit of priority from European Patent Application No. 10 305 845.9 filed on Jul. 30, 2010, the entirety of which is incorporated by reference.

The present invention relates to a polymer mixture which is suitable for manufacturing casings for optical or electrical cables and lines, wherein, for producing a casing surrounding a cable core or line core, the polymer mixture is extruded around the casing and is subsequently cross-linked. This cross-linkable polymer mixture is not limited to certain cables or lines. The polymer mixture according to the invention is distinguished by the fact that it has a casing having a particularly high breaking elongation and/or flexibility at room temperature and also at low temperatures, for example, up to −40° C., as well as a high resistance against paraffinic and aromatic mineral oils, for example, machine oil, hydraulic oil, transmission oil, and/or cooling liquid. Accordingly, the cables or lines are constructed either with insulated electrical conductors or light wave conductors. However, it is also possible to use either insulated electrical conductors or light wave conductors.

### STATE OF THE ART

U.S. Pat. No. 6,830,777 B2 describes a cross-linkable polymer mixture for cable casings which contains polyethylene and an ethylene acrylate copolymer in mixture with silane which harden in the presence of water or steam while being cross-linked.

### OBJECT OF THE INVENTION

Compared to the state of the art, it is the object of the invention to provide an alternative cross-linkable polymer mixture for a casing of a cable or a line, and to provide a cable or a line with a casing of the cross-linked polymer mixture, wherein preferably the casing of the polymer mixture after having been cross-linked has an increased resistance against oils and a high flexibility also at low temperatures.

### GENERAL DESCRIPTION OF THE INVENTION

The invention meets this object with the features of the claims and in particular with a polymer mixture which is cross-linkable and halogen-free. The cross-linkable halogen-free mixture is particularly suitable for use as casing or lines. The polymer mixture according to the invention includes cross-linkable components which comprise or consist of an alkalene vinyl acetate copolymer with at least 40% by weight vinyl acetate units and in mixture therewith a polyalkalene polymer which includes dicarbonite acid groups, particularly to the limit of 0.2 to 2% by weight. The alkalene groups of both polymers of the cross-linkable components can be ethylene or propylene groups which are independent of each other optionally as acid anhydride groups and/or as ester groups. The polyalkalene polymer with dicarboxylic groups is preferably a polyalkalene graft copolymer in which a polyalkelene polymer is grafted with at least one compound containing dicarbonic acid groups, such as, for example, polyethylene, polypropylene and/or polyethylene-polypropylene copolymer which is grafted with maleic acid anhydride or an aryl dicarbonic acid.

The cross-linkable components of the polymer mixture according to the invention preferably have or consist of the alkalene vinyl acetate copolymer with at least 40% by weight vinyl acetate units, preferably 50 to 70% by weight vinyl acetate units and a polyalkalene polymer with dicarbonic acid groups, particularly a polyalkalene graft copolymer whose grafted groups contain dicarbonic acid groups. A preferred alkalene vinyl acetate copolymer is ethylene vinyl acetate copolymer, available under the name EVA, EVAC, and EVM, especially preferred with a content of vinyl acetate units of at least 50% by weight, 60% by weight and/or 70% by weight and mixtures thereof.

The mixture according to the invention preferably contains or consists of as cross-linkable components:

with 5 to 30 phr, preferably 10 to 25 phr, more preferably 15 to 20 phr of a mixture of polyethylene graft copolymers with a content of 0.2% to 2% dicarbonic acid units, preferably 0.5% to 1.0% by weight dicarbonic acid units, wherein the alkalene units are preferably ethylene and/or propylene and the dicarbonic acid units are preferably maleic acid, and
95 to 70 phr, preferably 90 to 75 phr, more preferably 85 to 80 phr, even more preferably 80 phr of an alkalene vinyl acetate copolymers or a mixture of alkalene vinyl acetate copolymers with a total of 40% by weight vinyl acetate units or more, preferably 50% to 70% by weight, more preferred 60% by weight vinyl acetate units, wherein the alkalene vinyl acetate copolymers, are particularly ethylene vinyl acetate copolymers. It has been found that the cross-linkable components of the polymer mixture cross-link into a polymer mixture with the additional components thereof, particularly a flame retardant filler, kaolin, softeners, ageing protection agents, UV-stabilizers, as well as optionally coloring agents and/or auxiliary processing agents in the presence of the cross-linking system contained in the mixture. In this cross-linked polymer mixture, the additional components or aggregates are bound which do not contain any groups which are reactive with the alkalene vinyl acetate copolymers or the polyalkalene polymer with dicarbonic acid groups, so that the cross-linked product has a halogen-free casing with high resistance to oils and low temperatures, particularly a good flexibility at up to −40° C.

The resistance to oil is characterized in that the cross-linked polymer mixture has after ageing in oil at 70° C. for 7 days and/or at 100° C. for 24 h or longer a change of the tensile strength of at most 30% and of the rupture elongation of at most 40%. The oil preferably is the aromatic mineral oil IRM903. Particularly preferred, the cross-linked polymer mixtures have the flexibility at low temperatures in combination with the resistance to ageing in oil, more preferred against ageing in 2, 5 or more, particularly preferred against ageing in all liquids of the following group which, among others, contains mineral oils and cooling agents: Mineral oils IRM902, IRM903, transmission oils Cognis Breox SL 320, Mobilgear SHC XMP 320, Shell Tivela SC 320, Texaco Meropa 320, Texaco Pinnacle WM 320, Tribol 1710/320, hydraulic oils Mobil SHC 524, Texaco Rando HDZLT 32, Texaco Rando WM 32 and/or cooling liquids Dowcai 10 (50% ethylene glycol), Havoline XLC +B −40 (50% ethylene glycol).

The low temperature flexibility at −40° C. is characterized in that the polymer mixture cross-linked in accordance with the invention has in the test for resistance to cold according to IEC 60811-1-4 preferably additionally a cold expansion at −40° C. of at least 40%.

In addition to the high resistance to oil and the flexibility at low temperatures at −40° C., polymer mixtures cross-linked according to the invention have good mechanical properties, such as, a rupture elongation of about 300-450% at room temperature and preferably have a resistance to abrasion of <300 mm³, more preferred 240-270 mm³ according to ISO 4649 Method. A which corresponds, for example, to those of casing mixtures on the basis of PCP.

Generally preferred, polymer mixtures cross-linked according to the invention have an additional high resistance to torsional loads, particularly at −35° C., preferably −40° C., with torsions in any direction by 100° per meter in particular per meter of line, over 5,000 cycles or more. In addition, polymer mixtures cross-linked according to the invention exhibit preferably a low water absorption, for example, at most 15 mg/cm² at 70° C. over 168 h (particularly according to IEC60811-1-3; 9-2), particularly preferred in combination with a high flame retardance, for example, against a flame duration of 480 s (particularly in accordance with IEC60332-1-2), even more preferred in combination with a low corrosiveness, for example, a pH value of at most 4.5, and a maximum conductivity of 10 μS/mm (particularly in accordance with IEC60754-1/-2).

At the present time, it is assumed that the combination of properties of a high chemical resistance against oil with the high flexibility even at low temperatures, which a casing of the cross-linked polymer mixture has, goes back to its content of softener and fillers in combination with the production of chemical bonds between the alkalene vinyl acetate copolymer and the polyalkalene polymer with dicarbonic acid groups in the presence of the cross-linking system, as it is in particular a radical starter system with polymerization accelerator.

Preferred components or additives of the polymer mixture, which do not have groups, which are reactive with the cross-linkable components are flame retardant fillers, particularly selected from aluminum hydroxide, magnesium hydroxide and/or magnesium carbonate, to a total of 100 to 250 phr, preferred 140 to 180 phr, more preferred 150 to 160 phr, kaolin, particularly selected from kalcined kaolin, hard kaolin, soft kaolin and/or talcum up to 10 to 30 phr, more preferred 12 to 15 phr, particularly 12.5 phr, softener, in particular adipat and/or sebacat, particularly Di-2-octylsebacat, up to 1 to 25 phr, preferably 10 to 20 phr, more preferably 13 to 15 phr, ageing protection agent, for example, TMQ(2,2,4-trimethyl-1,2-dihydrochinolin), ZMBI(zinc salt of the 2-mercaptobenzimidazols), MMBI(methylmercaptobenzimidazol), ZMMBI (zinc salt of 4- and 5-methyl-2-mercaptobenzimidazols), combination of TMQ with ZMBI, MMBI and ZMMBI, SDPA(styrenated diphenylamine), other ASM (class of the substituted diphenylamine), preferably SDPA up to 1 to 5 phr, preferably 2 to 3 phr, optionally coloring agent which has light fastness, is thermally stable, is stable against the reaction conditions and reactants occurring during the peroxidic cross-linking, is stable particularly against peroxide radicals, and preferably has resistance to climate conditions, for example, pigments, for example, Paligon Red K 3580 or soot or titanium dioxide with a UV-stabilizer for light colors, up to 1 to 5 phr, particularly 2.2 phr,

optionally auxiliary processing agents, in particular waxes, carbonic acid amides, stearic acid, fatty acid derivatives and/or other compounds suitable for EVAC-mixtures, preferably carnauba wax, or a combination of stearic acid and 2,2-iminodiethanol(polyplastol 51) up to 3 to 10 phr, preferably 5 to 7 phr.

The parts indicated in the statements concerning polymer mixture are to be understood as “parts per hundred rubber,” i.e., the parts per weight of the components are taken in relation to 100 of the cross-linkable components in the mixture.

Used as a cross-linking system is preferably a peroxide compound, for example, [1,3(or 1,4)-phenylenbis(1-methylethyliden)]bis[tertbutyl]peroxide, preferably with a co-activator, preferably a triallyicyanurate, for example, 2,4,6-tris(allyloxy)-1,3,5-triazin. Alternatively, the cross-linking system may include or may consist of a co-activator in connection with the irradiation of the mixture with ionizing radiation.

The polyalkalene polymer with dicarbonic acid groups is preferably a graft copolymer in which polyethylene, polypropylene and/or ethylene-propylene copolymer are grafted with a compound containing dicarbonic acid groups, for example, with a maleic acid anhydride, and/or an aryldiacidester.

### DETAILED DESCRIPTION OF THE INVENTION

The invention will now be described in more detail with reference to the figures which illustrate the mechanical properties of polymer mixtures cross-linked in accordance with the invention, namely, in

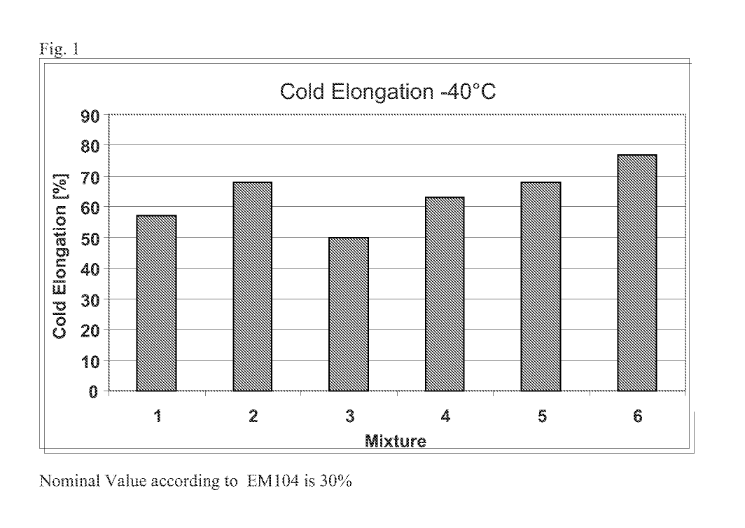

FIG. 1 the cold elongation at −40° C. is shown,

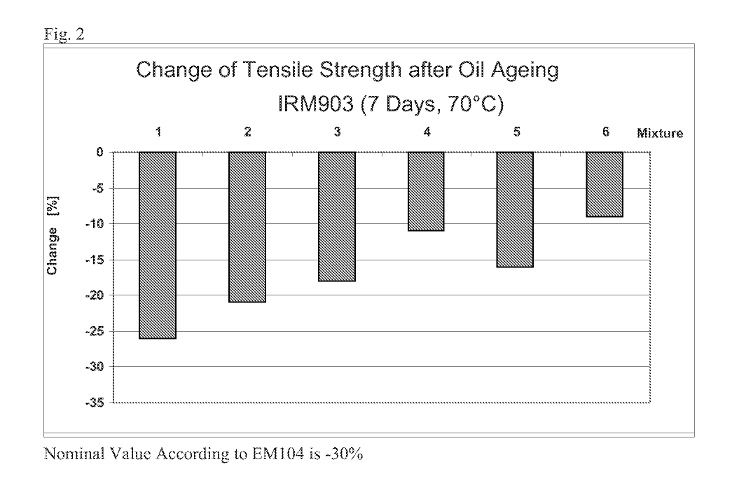

FIG. 2 shows the tensile strength after ageing the polymer mixture in oil for 7 days at 70° C., and

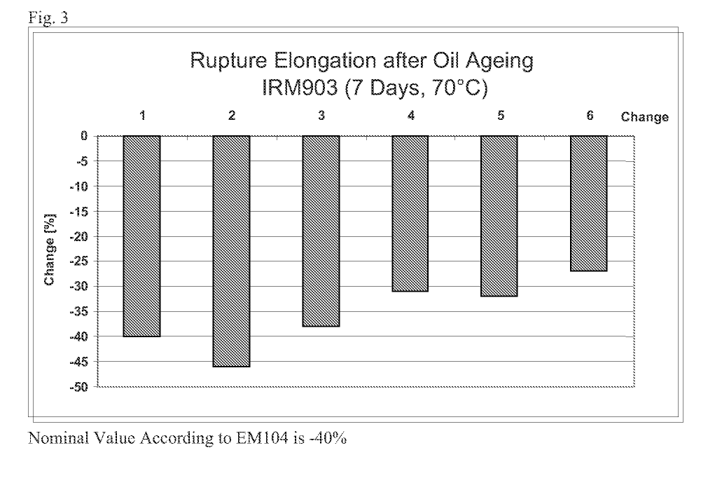

FIG. 3 shows the change of the rupture elongation after ageing in oil at 70° C. for 7 days.

Polymer mixtures according to the invention and comparative mixtures were produced by mixing the components indicated in the following table in phr after premixing in a stage in a 2 liter laboratory kneader with a kneader filling factor of 0.7.

TABLE
Composition of Polymer Mixtures

| | Comparative | | | | | |
|---|---|---|---|---|---|---|
| | Mixture | | Mixture | | | |
| Component | 1 | 2 | 3 | 4 | 5 | 6 |
| Levapren | 20 | 30 | 40 | 50 | | |
| 700 HV | | | | | | |
| Levapren | | | | | 80 | 80 |
| 600 HV | | | | | | |
| Levapren | 60 | 50 | 40 | 30 | | |
| 500 HV | | | | | | |
| Polyalkalene | 20 | 20 | 20 | 20 | 20 | 20 |
| Polymer with | | | | | | |
| dicarbonic acid | | | | | | |
| groups | | | | | | |
| Diphenylamin | 2.0 | 2.0 | 2.0 | 2.0 | 2.0 | 2.0 |
| Protective | 1.5 | 1.5 | 15 | 1.5 | 1.5 | 1.5 |
| Agent | | | | | | |
| Titanium | 2.0 | 2.0 | 2.0 | 2.0 | 20 | 2.0 |
| Dioxide | | | | | | |
| Alluminum | 150 | 150 | 150 | 150 | 150 | 160 |
| Hydroxide | | | | | | |
| Calcinated | 12.50 | 1250 | 12.50 | 12.50 | 12.50 | 12.50 |
| Kaolin | | | | | | |
| Softener | 13 | 15 | 15 | 15 | 13 | 15 |
| Color Pigment | 2.2 | 2.2 | 2.2 | 2.2 | 2.2 | 2.2 |
| Wax | 5.0 | 5.0 | 5.0 | 5.0 | 5.0 | 5.0 |
| Coactivator | 0.5 | 0.5 | 0.5 | 0.5 | 0.5 | 0.5 |
| Peroxide | 8.0 | 8.0 | 8.0 | 8.0 | 8.0 | 8.0 |
| Density | 1.48 | 1.49 | 1.49 | 1.50 | 1.50 | 1.52 |
| Sum phr | 298.70 | 298.70 | 298.70 | 298.70 | 296.70 | 308.70 |

In the example mixtures, Levapren® is used as ethylene vinyl acetate copolymer (obtainable from Lanxess), wherein Levapren 700 contains approximately 70% by weight, Levapren 600 about 60% by weight, and Levapren 500 approximately 50% by weight vinyl acetate units.

The polyalkylene polymer with carbonic acid groups is an ethylene-propylene-octen-copopymer, which is grafted with maleic acidanhydride and contains approximately 0.5 to 1% by weight maleic acid units, the diphenylamine is contained as an example for an ageing protection agent, calzined kaolin is added as an example for a kaolin filler, wax is added as an example for an auxiliary processing agent.

For the cross-linkable components, which in the examples consist of Levapren and the polyalkalene polymer with dicarbonic acid groups, the table indicates portions per weight, and in relation to the other, not cross-linkable aggregates the portions per weight are indicated in phr, i.e., on the basis of the total weight of the cross-linkable components Levapren and polyalkalene polymer with carbonic acid groups.

The mixtures were extruded as casings of a cable or a line and were subsequently cross-linked, preferably at a temperature of about 160-200° C. up to complete cross-linking.

The cold elongation at −40° C. in accordance with EN60811-1-4 was measured with the aid of sample pieces which consisted of the cross-linked polymer mixture in accordance with the example compounds. The measurement results are shown in FIG. 1 and make it clear that the mixtures according to the invention have after cross-linking a cold elongation at −40° C. of at least 50%; this is clearly above the level of the nominal value of 30% of the EM104 (DIN EN 50264-1). Accordingly, mixtures cross-linked in accordance with the invention have at −40° C. a cold elongation of at least 40%, preferably at least 50%, more preferably at least 60%, even more preferably at least 70%, for example, measured in accordance with EN60811-1-4. Particularly preferably, the mixtures have a cold elongation of at least 30%, preferably at least 40% even at −45° C., even more preferably at least 30% at −50° C.

The chemical constancy of the cross-linked polymer mixtures according to the invention was tested by oil ageing, for example, storage of the sample pieces in oil at 70° C. for days, wherein the tensile strength and the rupture elongation were measured before and after oil ageing. The change of the tensile strength of cross-linked polymer mixtures according to the invention is shown in FIG. 2, the change of the rupture elongation is shown in FIG. 3, wherein the oil used was a standard motor oil RIM903.

The data shown in FIG. 2 for the change of the tensile strength demonstrate that particularly the mixtures no. 3 to no. 6 have only a slight drop of the tensile strength after oil ageing, wherein also the comparative mixtures no. 1 and no. 2 are still in the range of the decrease of the tensile strength by at most 30%, which is required by EM104.

Therefore, mixtures cross-linked according to the invention have a reduction of the tensile strength after oil ageing, for example, in motor oil, by at most 30%, preferably at most 20%, more preferably by at most 10%, for example, measured according to DIN EN60811-2-1.

The rupture elongation of polymer mixtures cross-linked according to the invention, for example, in the test according to EN60811-2-1 is reduced after storage in transmission oil, hydraulic oil and/or mineral oil, and after storage in a cooling liquid with approximately 50% ethylene glycol by at most about 40%.

The evaluation of the measurement of the rupture elongation after oil ageing, illustrated in FIG. 3 as a relative change, makes it clear that polymer mixtures cross-linked according to the invention exhibit a decrease of the rupture elongation of at most 40% after oil ageing, preferably by at most 35%, more preferred by at most 30%, for example, measured according to IEC60811-2-1 part 10. The mixtures 3 to 6 cross-linked according to the invention have smaller reductions of the rupture elongation after oil ageing than mixtures 1 and 2, and meet all requirements concerning a maximum change of the rupture elongation of +/−40% in accordance with EM104 (DIN EN 50264-1).

The example mixtures made it clear that preferably the alkalene vinyl acetate copolymer contains at least 60% by weight vinyl acetate units. It is also more preferred that the alkalene vinyl acetate copolymer has essentially a uniform distribution of the content of vinyl acetate units, so that, for example, a mixture of two vinyl acetate copolymers, of which one has a higher content of vinyl acetate units than the other, is less preferred.

The following table shows additional properties of polymer mixtures cross-linked in accordance with the invention, for example, the resistance against high temperatures, against additional oils, as well as against IN Oxal acid and IN sodium hydroxide with the aid of the changes of the tensile strength and rupture elongation after storage in the media.

| | Test | Test | Limit | Type of | Mixtures | | | | | |
|---|---|---|---|---|---|---|---|---|---|---|
| No. | Test Standard | Conditions | Values | Construction | 1 | 2 | 3 | 4 | 5 | 6 |
| 1 | Tensile | — | 6.5 N/mm² | | 4 | | 4 | 4 | 4 | 4 |
| | Strength | | (typically | | | | | | | |
| | IEC60840; | | 10-11 N/mm²) | | | | | | | |
| | 12-4-3 | | | | | | | | | |
| 2 | Rupture | — | 125% | EM104 | 4 | | 4 | 4 | 4 | 4 |
| | Elongation | | (typically | (EN50264-1) | | | | | | |
| | IEC60840; | | 300-450%) | | | | | | | |
| | 12-4-3 | | | | | | | | | |
| 3 | Hot Air | 100° C., | Change of | | 4 | | 4 | 4 | 4 | 4 |
| | Ageing | 168 | tensile | | | | | | | |
| | IEC60840; | hours | strength | | | | | | | |
| | 12-4-3 | | max. ±30% | | | | | | | |
| | | | Change of | | | | | | | |
| | | | rupture | | | | | | | |
| | | | elongation | | | | | | | |
| | | | max ±30% | | | | | | | |
| 4 | Heat | 200° C., 15 min. | Elongation | | 4 | | | | 4 | 4 |
| | Expansion | 20 N/cm² | under load | | | | | | | |
| | IEC60502-2; | load | max. 175% | | | | | | | |
| | 19-11 | | Elongation | | | | | | | |
| | | | after load | | | | | | | |
| | | | max. 15% | | | | | | | |
| 5 | Storage in | 100° C., 24 | Change of | | 4 | | | | | 4 |
| | IRM902 | hours | tensile | | | | | | | |
| | IEC60502-2; | | strength | | | | | | | |
| | 19-12 | | max. ±30% | | | | | | | |
| | | | Change of | | | | | | | |
| | | | rupture | | | | | | | |
| | | | elongation | | | | | | | |
| | | | Max. ±40% | | | | | | | |
| 6 | Storage | 100° C., 24 | Change of | | 4 | | | | | 4 |
| | in | hours | tensile | | | | | | | |
| | IEC60502- | | strength | | | | | | | |
| | 2; | | max. ±30% | | | | | | | |
| | Cognis | | Change of | | | | | | | |
| | Breox | | rupture | | | | | | | |
| | SL320 | | elongation | | | | | | | |
| | 19-12 | | ±40% | | | | | | | |
| 7 | Storage | 100° C., 24 | Change of | | 4 | | | | | 4 |
| | in | hours | tensile | | | | | | | |
| | Mobilgear | | strength | | | | | | | |
| | IEC60502- | | max. ±30% | | | | | | | |
| | 2; | | Change of | | | | | | | |
| | SHC | | rupture | | | | | | | |
| | XMP320 | | elongation | | | | | | | |
| | 19-12 | | ±40% | | | | | | | |
| 8 | Storage | 100° C., 24 | Change of | | 4 | | | | | 4 |
| | in Shell | hours | tensile | | | | | | | |
| | IEC60502- | | strength | | | | | | | |
| | 2; | | max. ±30% | | | | | | | |
| | Tivela SC | | Change of | | | | | | | |
| | 320 | | rupture | | | | | | | |
| | 19-12 | | elongation | | | | | | | |
| | | | ±40% | | | | | | | |
| 9 | Storage | 100° C., 24 | Change of | | 4 | | | | | 4 |
| | in Texaco | hours | tensile | | | | | | | |
| | IEC60502- | | strength | | | | | | | |
| | 2; | | max. ±30% | | | | | | | |
| | Meropa | | Change of | | | | | | | |
| | 320 | | rupture | | | | | | | |
| | 19-12 | | elongation | | | | | | | |
| | | | ±40% | | | | | | | |
| 10 | Storage | 100° C., 24 | Change of | | 4 | | | | | 4 |
| | in Texaco | hours | tensile | | | | | | | |
| | IEC60502- | | strength | | | | | | | |
| | 2; | | max. ±30% | | | | | | | |
| | Pinnacle | | Change of | | | | | | | |
| | WM 320 | | rupture | | | | | | | |
| | 19-12 | | elongation | | | | | | | |
| | | | ±40% | | | | | | | |
| 11 | Storage | 100° C., 24 | Change of | | 4 | | | | | 4 |
| | in | hours | tensile | | | | | | | |
| | IEC60502- | | strength | | | | | | | |
| | 2; | | max. ±30% | | | | | | | |
| | Tribol | | Change of | | | | | | | |
| | 1710/320 | | rupture | | | | | | | |
| | 19-12 | | elongation | | | | | | | |
| | | | ±40% | | | | | | | |
| 12 | Storage | 100° C., 24 | Change of | | 4 | | | | | 4 |
| | in Mobil | hours | tensile | | | | | | | |
| | IEC60502- | | strength | | | | | | | |
| | 2; | | max. ±30% | | | | | | | |
| | SHC 524 | | Change of | | | | | | | |
| | 19-12 | | rupture | | | | | | | |
| | | | elongation | | | | | | | |
| | | | ±40% | | | | | | | |
| 13 | Storage | 100° C., 24 | Change of | | 6 | | 4 | 4 | 4 | 4 |
| | in Texaco | hours | tensile | | | | | | | |
| | IEC60502- | | strength | | | | | | | |
| | 2; | | max. ±30% | | | | | | | |
| | Rando WM | | Change of | | | | | | | |
| | 32 | | rupture | | | | | | | |
| | 19-12 | | elongation | | | | | | | |
| | | | ±40% | | | | | | | |
| 14 | Storage | 60° C., 24 | Change of | | 4 | | | | | 4 |
| | in | hours | tensile | | | | | | | |
| | Havoline | | strength | | | | | | | |
| | IEC60502- | | max. ±30% | | | | | | | |
| | 2; | | Change of | | | | | | | |
| | XLC + B- | | rupture | | | | | | | |
| | 40 | | elongation | | | | | | | |
| | 19-12 | | ±40% | | | | | | | |
| 15 | Storage | 70° C., 168 | Change of | EM104 (EN50264- | 6 | | 4 | 4 | 4 | 4 |
| | in IRM903 | hours | tensile | 1) | | | | | | |
| | IEC60811- | | strength | | | | | | | |
| | 2-1; | | max. ±30% | | | | | | | |
| | 10 | | Change of | | | | | | | |
| | | | rupture | | | | | | | |
| | | | elongation | | | | | | | |
| | | | ±40% | | | | | | | |
| 16 | Storage in | 23° C., 168 | Change of | EM104 | | | | | | 4 |
| | 1N- | hours | tensile | (EN50264-1) | | | | | | |
| | IEC60811- | | strength | | | | | | | |
| | 2-1; | | max. ±30% | | | | | | | |
| | Oxalic | | Change of | | | | | | | |
| | acid | | rupture | | | | | | | |
| | 10 | | elongation | | | | | | | |
| | | | min. 100% | | | | | | | |
| 17 | Storage in | 23° C., 168 | Change of | EM104 | | | | | | 4 |
| | 1N- | hours | tensile | (EN50264-1) | | | | | | |
| | IEC60811- | | strength | | | | | | | |
| | 2-1; | | max. ±30% | | | | | | | |
| | Sodium | | Change of | | | | | | | |
| | hydroxide | | rupture | | | | | | | |
| | 10 | | elongation | | | | | | | |
| | | | min. 100% | | | | | | | |
| 18 | Cold | −40° C. | Min. 40% | — | 4 | | 4 | 4 | 4 | 4 |
| | Elongation | | (typically | | | | | | | |
| | IEC6081 1- | | 45-60%) | | | | | | | |
| | 1-4 | | | | | | | | | |
| | 8-4 | | | | | | | | | |
| 19 | Abrasion | — | <300 mm³ | — | 4 | | | | | 4 |
| | ISO4649 | | (typically: | | | | | | | |
| | | | 240-270 mm³) | | | | | | | |
| 20 | Torsion | −35° C./−40° C.; | No cracks | — | | | | | | 4 |
| | Test— | ±100°/m; 5000 | | | | | | | | |
| | | cycles | | | | | | | | |
| 21 | Water | 70° C., 168 | Max. | EM104 (EN50264- | | | | | 4 | 4 |
| | Absorption | hours | 15 mg/cm2 | 1) | | | | | | |
| | 60811-1-3 | | Weight | | | | | | | |
| | 9-2 | | increase | | | | | | | |
| 22 | Ozone | 250 ppm | No cracks | | 4 | | 4 | 4 | 4 | 4 |
| | Resistance | Ozone; 25° C.; | | | | | | | | |
| | IEC60502-2 | 24 h | | | | | | | | |
| | 19-10 | | | | | | | | | |
| 23 | Corrosiveness- | — | pH value | — | | | | | | 4 |
| | pH- | | min. 4.5; | | | | | | | |
| | IEC60754-1/-2 | | conductivity | | | | | | | |
| | Value + | | max. 10 μS/mm | | | | | | | |
| | Conductivity | | | | | | | | | |
| 24 | What to Do in | Duration of | Distance | — | | | | | | 4 |
| | the | the flame | 1 > 50 mm; | | | | | | | |
| | IEC60332-1-2 | 480 s | Distance | | | | | | | |
| | Case of Fire | | 2 < 540 mm | | | | | | | |

In the table, a 4 means that the intended value or the limit value is at least reached, and a 6 means that the limit value is not reached; a field without indication means that this value was not determined.

1. Cross-linkable halogen-free polymer mixture for use as casings of electrical and/or optical cables or lines, said polymer mixture comprising:
as cross-linkable components, 95-70 phr of at least one alkalene vinyl acetate copolymer with at least 40% by weight vinyl acetate units and 5-30 phr of at least one polyalkalene polymer with a content of 0.2 to 2% by weight dicarbonic acid groups,
as well as a cross-linking system,
100 to 250 phr of a flame-retardant filler,
10 to 30 phr kaolin; and
1 to 25 phr softener.

2. Cross-linkable polymer mixture according to claim 1, wherein the cross-linkable components are composed of the alkalene vinyl acetate copolymer and the polyalkalene polymer with carbonic acid groups.

3. Cross-linkable polymer mixture according to claim 1, wherein the dicarbonic acid groups of the polyalkalene polymer are at least partially acid and hydride groups and/or are esterified.

4. Cross-linkable polymer mixture according to claim 1, wherein the polyalkalene polymer with dicarbonic acid groups is a polyalkalene graft copolymer.

5. Cross-linkable polymer mixture according to claim 4, wherein the polyalkalene graft copolymer contains grafted maleic acid and hydride and/or oral acid ester.

6. Cross-linkable polymer mixture according to claim 1, wherein the alkalene units of the polyalkalene polymer are ethylene and/or propylene.

7. Cross-linkable polymer mixture according to claim 1, wherein the alkalene vinyl acetate copolymer is an alkalene vinyl acetate copolymer or a mixture of alkalene vinyl acetate copolymer with at least 50 to at least 70% by weight vinyl acetate units.

8. Cross-linkable polymer mixture according to claim 1, wherein the alkalene units of the alkalene vinyl acetate copolymer are ethylene and/or propylene.

9. Cross-linkable polymer mixture according to claim 1, wherein the cross-linking system contains a peroxide and a coactivator compound.

10. Cross-linkable polymer mixture according claim 1, wherein the cross-linking system contains a coactivator compound activatable by ionizing radiation.

11. Cross-linkable polymer mixture according to claim 1, wherein said mixture includes a content of ageing protecting agent, UV-stabilizer, coloring agent and/or auxiliary processing agent.

12. Method of manufacturing a casing for electrical and/or optical cables or lines with electrical conductors or light wave conductors by extrusion of a cross-linkable polymer mixture, characterized in that the polymer mixture contains a cross-linkable polymer mixture according to claim 1 and the polymer mixture is cross-linked after extrusion.

13. Cable or line with a casing obtainable by extruding and cross-linking a cross-linkable polymer mixture, wherein the polymer mixture is one according to claim 1, wherein the casing has a rupture elongation of at least 300% at room temperature and a rupture elongation of at least 40% at −40° C.

14. Cable or line according to claim 13, wherein the casing has a reduction of the tensile strength of at most 30% after storage in mineral oil for 7 days at 70° C.

15. Cable or lines according to claim 13, wherein the casing has an abrasion resistance of <300 mm³ according to ISO4649 Method A.
